(19) United States
(12) Patent Application Publication
(10) Pub. No.: US 2013/0309287 A1
(43) Pub. Date: Nov. 21, 2013

(54) RODENT BAIT PACKED IN A BIODEGRADABLE FOIL

(71) Applicants: Marcelo Hoyos, Buenos Aires (AR); Ernesto Mino Naranjo, Buenos Aires (AR)

(72) Inventors: Marcelo Hoyos, Buenos Aires (AR); Ernesto Mino Naranjo, Buenos Aires (AR)

(73) Assignee: BASF SE, Ludwigshafen (DE)

(21) Appl. No.: 13/514,647

(22) PCT Filed: Dec. 9, 2010
(86) PCT No.: PCT/EP2010/069227

§ 371 Date: May 31, 2013

(30) Foreign Application Priority Data
Dec. 11, 2009 (EP) 09178812.5

(51) Int. Cl. A01N 25/34

(52) U.S. Cl. CPC A01N 25/34
USPC 424/405; 424/84

(57) ABSTRACT

The present invention relates to a bait system comprising a rodent bait, which is packed in a biodegradable foil containing polyester and starch. The present invention also relates to a method for controlling rodents, comprising the steps of a) packing said rodent bait in said biodegradable foil, and b) offering the packed bait to rodents. It also relates to a bait system comprising, as separate components, a) said rodent bait, and b) said biodegradable, for combined use in controlling rodents.

The present invention relates to a bait system comprising a rodent bait, which is packed in a biodegradable foil containing polyester and starch. The present invention also relates to a method for controlling rodents, comprising the steps of a) packing said rodent bait in said biodegradable foil, and b) offering the packed bait to rodents. It also relates to a bait system comprising, as separate components, a) said rodent bait, and b) said biodegradable, for combined use in controlling rodents. Combinations of preferred embodiments with other preferred embodiments are within the scope of the present invention.

Various rodent baits are known: WO1993/01712 discloses a rodent bait package comprising a bait composition contained in a package, wherein the package is made of a material which has a bittering agent or repellent incorporated. Various materials for packaging are disclosed, such as plastics. Disadvantages are, that the packaging material is not biodegradable and that the foil requires an additional treatment with the bittering agent.

DE 198 37 064 discloses a paste-like rodenticidal bait, which is mixed with fat of a melting point in the range of 20 to 70° C. resulting in resistance to moisture, and which is packed in a foil made of biodegradable material into ready to use portions. Various biodegradable materials are suggested, such as a blend of polyester and starch. Disadvantage of this bait system are: It is only for paste-like baits. The viscosity of the paste has to be adjusted in order to achieve a good wetting of the foil on the outside, which results in a high attractivity for rodents. It is limited to fats of a certain melting point.

DE 44 34 839 discloses a rodenticidal bait system, wherein a mixture of rodenticide and carrier is packed in a foil, which has an O2-permeability of at least 250 cm3/m2*24h*bar and a permeability for water vapor of up to 100 g/m2*24h*bar, and which is packed in ready to use portions. Various foil materials are suggested, such as polyterephthalic acid glycol ester. disadvantage is, that preferably multilayer foils have to be used.

WO 2009/095878 discloses a rodenticide preparation comprising a poisoned bait, which is packaged into biodegradable film based on a biopolymer palatable for infesting murine species. The biopolymer was Mater-Bi®, which is available in different grades of 60-70 wt % starch and 30-40 wt % vinyl-alcohol/ethylene (60/40 mol/mol) copolymer according to Bastioli et al., Journal of Environmental Polymer Degradation, 1993, 1, 181-191 (“Mater-Bi: Properties and Biodegradability”).

Object of the present invention was to identify a rodent bait system, which results in no waste after it is taken away by rodents. Further on said system should be based on industrially available materials, it should work with commercial bait formulation, it should be storage stable, it should be attractive to rodents, and it should be easy and safe to handle for the pest management operators.

These objects were achieved with a bait system comprising a rodent bait, which is packed in a biodegradable foil containing polyester and starch.

Typically, the rodent bait comprises an rodenticide. For the purposes of the invention, the term rodenticide means a solid or liquid active ingredient which is suitable for controlling rodent pests, preferably rodents, in particular rats and mice. Preferably, the bait comprises a rodenticide from the class of anticoagulants.

Suitable classes of rodenticides comprise:
anticoagulants, in particular coumarin derivatives such as brodifacoum, bromadiolone, coumachlor, coumafuryl, coumatetralyl, difenacoum, difethialone, flocoumafen and warfarin, indandione derivatives such as chlorophacinone, diphacinone and pindone;
inorganic rodenticides such as arsenic oxide, phosphorus, potassium arsenite, sodium arsenite, thallium sulfate and zinc phosphide;
organochlorine rodenticides such as γ-HCH, HCH and linden;
organophosphorus rodenticides such as phosacetim;
pyrimidineamine rodenticides such as crimidine;
thiourea rodenticides such as antu;
urea rodenticides such as pyrinuron;
garden rodenticides such as scilliroside and strychnine;
unclassified rodenticides such as bromethalin, chloralose, a-chlorohydrin, ergocalciferol, fluororoacetamide, flupropadine, norbormide, sodium fluoroacetate and vitamin D3.

Preferred rodenticides are anticoagulants, in particular coumarin derivatives, particularly preferably flocoumafen and difenacoum. Furthermore preferred are mixtures of an anticoagulant with ergocalciferol or vitamin D3. Zinc phosphide is equally preferred.

The rodenticide in the rodent bait amounts to preferably 0.0005 to 99.5% by weight, more preferably 0.001 to 50% by weight, most preferably from 0.001 to 1.0° % by weight and especially preferred from 0.001 to 0.01% by weight. The amount depends usually on the level of rodenticidal activity and the type of formulation.

The rodent bait may be a solid, liquid or paste-like formulation. Examples of bait formulations are food baits, in particular seed cereal baits and suitable treatment agents, pellets (die-formed articles), wax-coated pellets, molten-wax blocks, compressed or extruded wax blocks, pastes, gels, granules and foams. Preferably the bait is a solid formulation, especially a block bait. More preferably, the bait does not loose its shape when exposed for 12 h to a temperature of 45° C., preferably 55° C. and more preferably 70° C. Most preferably, the rodent bait is a block bait.

In another preferred embodiment, the bait is a block bait, such as molten-wax blocks, compressed or extruded wax blocks.

Usually, the block bait has a weight of 1 to 30 g, preferably 2 to 10 g, more preferably 2.0 to 6.0 g, and especially from 3.0 to 5.0 g. In particular, the weight is in the range of 3.1 to 4.0 g. Typically, at least 80% (preferably at least 95%) of the block baits are said ranges.

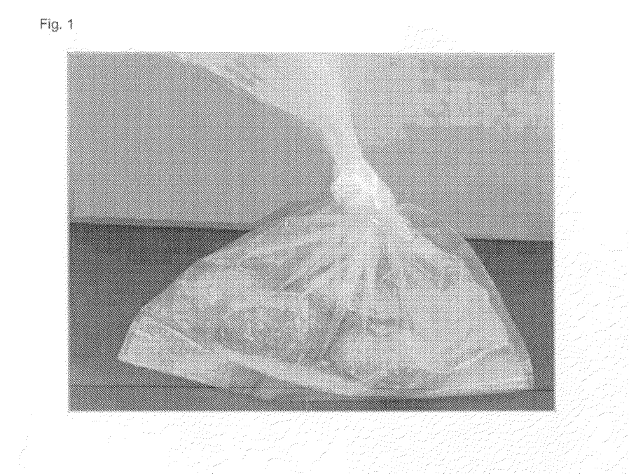

Preferably, block baits which comprise a rodenticide, a mixture of feedstuffs, typically cereal grains, coarse cereal meals or cereal powders, paraffin wax, and if appropriate adjuvants. Block baits are usually prepared by casting, extruding or compressing. Block baits may be prepared in many shapes which allow them for example to be hung up or fastened in a bait station. In a preferred embodiment, the wax blocks comprise a multiplicity of corners because the animals prefer to gnaw at corners. Suitable blocks are for example described in WO 2002/47896 FIGS. 1 and 2, to which reference is made.

Usually, the block bait does not loose its shape when exposed for 12 h to a temperature of 45° C., preferably 55° C. and more preferably 70° C. All ingredients, which are present in the rodent bait (e.g. the block bait) in an amount of at least 1 wt %, preferably at least 10 wt %, have typically a melting point of at least 45° C., preferably at least 55° C. and more preferably at least 60° C. It was found to be advantageous that the block bait remains in shape at elevated temperatures, because in the field the bait system tends warm up, and the rodents do not like to carry away molten block baits and they reject to eat molten block baits because the palatability is reduced.

Typically, the block bait has a length of 1.5 cm to 15 cm, a width of 1.0 to 15 cm and a height of 0.3 to 15 cm. Preferably, the block bait has a length of 2.0 cm to 7.0 cm, a width of 1.3 to 6.0 cm and a height of 0.7 to 4.0 cm. In particular, the block bait has a length of 2.0 cm to 5.0 cm, a width of 1.4 to 3.0 cm and a height of 0.7 to 2.0 cm. In case the block bait has a cylindrical shape the width corresponds to the diameter.

In another preferred embodiment, at least two dimensions (such as length and width) of the block bait have a size of at least 1.0 cm, preferably at least 1.5 cm.

The form of the block bait is preferably substantially spherical (e.g. forms like an egg, pellet, sphere, prolate spheroid (like an American football), oblate spheroid). In a further embodiment, the form of the block bait is free of corner points. Examples for forms with at least one corner point are cuboids. For rodents it is much easier to catch with their teeth roundish or substantially spherical block baits.

The advantage of the aforementioned dimensions is that the packed bait will hardly be falling out of the biodegradable foil when the rodent is carrying the bait system to its nest, which is a safe and quite place for the colony of the rodents and where the bait can be eaten by all members of the rodent colony. This is especially advantageous compared to smaller baits, such as pellets or granules, which could easily be spread out of the bait system when the rodent is carrying the bait system to its nest. It would be very dangerous to non-target species when bait is spread all around a place when the rodents are carrying the bait system to their nest or cave.

The advantage of the above mentioned type of block baits is that the rodent can easily carry the bait system to its nest or cave. In addition, the rodents prefer much more to carry this type of block baits to its nest for eating compared to a bait with similar total weight but composed of smaller or lighter bait units (e.g. pellets, granules, or grains).

Furthermore preferred as baits are pellets (die-formed articles). Such pellets comprise a rodenticide in a mixture with optionally powdered or ground feedstuffs, in particular cereal and thickeners, and other adjuvants. Pellets are usually prepared by compressing, extrusion and subsequent drying. The pellet size varies as a function of the target animals. Frequently, pellets are prepared in the form of cylinders of diameter 3 to 5 mm and a length of 5 to 10 mm.

A further preferred bait formulation are granules which, besides rodenticide, comprise a typically comminuted, for example ground feedstuff and, if appropriate, further adjuvant, e.g. a binder. The preparation of granules is described for example in EP-A 0 771 393.

Typically, the rodent bait comprises at least one rodenticide, at least one bait material, and one or more adjuvants. Preferably, the rodent bait comprises
(A) 0.0001 to 30% by weight of at least one rodenticide,
(B) 0.5 to 99.999% by weight of at least one bait material, and
(C) 0 to 94.999% by weight of one or more adjuvants.

Bait materials which are generally used are vegetable or animal foodstuffs and feed stuffs. Suitable examples are coarse cereal meals, cereal grains, flaked or cut cereals or cereal meals (for example of oats, wheat, barley, maize, soya, rice), flaked coconut, ground coconut, sugar syrups (for example obtained by hydrolyzing starch (glucose syrup), invert sugar syrup, beet sugar syrup, maple syrup), sugars (for example sucrose, lactose, fructose, glucose), grated nuts, ground nuts (for example hazelnut, walnut, almond), vegetable fat/oils (for example rapeseed oil, soya fat, sunflower oil, cocoa butter, peanut oil, peanut butter, corn oil), animal fats/oils (butter, lard, fish oil), proteins (for example dried skimmed milk, dried egg, protein hydrolysates) and minerals (for example common salt).

Preferred are vegetable foodstuffs such as oatmeal, flaked or cut cereals, wheat kernels, coarse wheat meals, wheat flour, maize meal, flaked coconut, ground coconut, glucose syrup, maple syrup, beet sugar syrup, sucrose, glucose, ground hazelnuts, ground walnuts, almond, rapeseed oil, soya fat, peanut oil, corn oil; animal fats such as butter; proteins such as, for example, dried egg and dried skimmed milk.

The bait comprises often one or more of the abovementioned bait materials. It is preferred to employ two different bait materials in the formulations according to the invention.

The bait preferably comprises from 10 to 99% by weight, especially preferably from 20 to 90% by weight, of the bait material.

The bait may comprise one or more attractants as adjuvant. For the purposes of the invention, an attractant is a substance (or substance mixture) which is a phagostimulant or which attracts the attention of the rodent pest to the bait without being a feedstuff proper in another way, in particular by odor (for example as a sexual attractant). Examples of attractants are pheromones, yeast, ground crustaceans, fecal matter, berries, chocolate, fish meal, meat, black pepper and flavor enhancers such as glutamates, in particular sodium glutamate and disodium glutamate. In general, the attractants amount to from 0 to 10% by weight, preferably from 0 to 1% by weight, based on the total formulation.

Further customary adjuvants comprise colorants, bittering agents, flow agents, binders, agents for improving weather resistance, and antioxidants. In general, the adjuvants used will depend on the nature of the bait formulation used.

Colorants are frequently added, and the bait formulation is thereby clearly logged as not for consumption, in order to avoid ingestion by mistake by humans or non-target animals. In particular, blue colorants serve to deter birds. However, they may also serve to detect the consumption of the bait in the rodent pests' feces or vomit.

Bittering agents serve to avoid incidental consumption by humans. Especially preferred is denatonium benzoate, which, in a suitable concentration (in general 1 to 200 ppm, in particular 5 to 20 ppm), has a most unpleasant taste for humans, but not for rodents.

Flow agents and binders are added as a function of the bait formulation type. Binders are capable of fixing the mixture according to the invention onto the surface of the bait component (for example cereal grains) or—in the case of pastes for example—impart structure and coherence. Flow agents such as mineral earths and aluminosilicates facilitate extrudation and they are therefore frequently used in pellets and extruded blocks.

Suitable agents for improving weather resistance are, for example, paraffin waxes.

Examples of suitable antioxidants are t-butylhydroquinone (TBHQ), butylated hydroxytoluenes and butylated hydroxyanisoles, preferably in an amount of from 10 ppm to 20 000 ppm.

The rodent bait may comprise a paraffin wax as mentioned above for several purposes. Paraffin waxes are typically alkane hydrocarbons (preferably with the general formula CₙH₂ₙ₊₂, wherein n is from 15 to 45), which are solid at 25° C. The melting point of the paraffin waxes are usually above 40° C., preferably above 50° C., more preferably above 58° C. and especially preferred above 62° C. Usually, the bait comprises up to 50 wt % parrafin wax, preferably up to 40 wt % and more preferably up to 30 wt % paraffin wax, based on the total weight of the bait.

Typically, the foil has a thickness in the range from 1 to 50 μm, preferably from 10 to 40 μm, more preferably from 15 to 30 μm, and especially preferred from 18 to 25 μm.

The foil containing polyester and starch is biodegradable. For the purposes of the present invention, a substance or a mixture of substances complies with the feature termed “biodegradable” if this substance or the mixture of substances has a percentage degree of biodegradation of at least 60% in the processes defined in DIN EN 13432. Other methods of determining biodegradability are described by way of example in ABNT 15448-1/2 and ASTM D6400.

The result of the biodegradability is generally that the foil breaks down within an appropriate and demonstrable period. The degradation may be brought about enzymatically, hydrolytically, oxidatively, and/or via exposure to electromagnetic radiation, such as UV radiation, and is mostly predominantly caused by exposure to microorganisms, such as bacteria, yeasts, fungi, and algae. An example of a method of quantifying the biodegradability mixes polyester with compost and stores it for a particular time. By way of example, according to DIN EN 13432, CO₂-free air is passed through ripened compost during the composting process and the compost is subjected to a defined temperature profile. Biodegradability is defined here by way of the ratio of the net amount of CO₂ liberated from the specimen (after deducting the amount of CO₂ liberated by the compost without the specimen) to the maximum possible amount of CO₂ liberated by the specimen (calculated from the carbon content of the specimen), this ratio being defined as the percentage biodegradability. Even after a few days of composting, biodegradable polyesters or biodegradable polyester mixtures generally show marked signs of degradation, for example fungal growth, cracking, and perforation.

The foil contains polyester and starch. Typically, the foil contains at least 20 wt % starch, preferably at least 40 wt %. It may contain up to 80 wt % starch, preferably up to 60 wt %. Typically, the foil contains at least 20 wt % polyester, preferably at least 40 wt %. It may contain up to 80 wt % polyester, preferably up to 60 wt %.

Polyesters are well known polymers. They comprises monomers in polymerized form, such as diols and diacids (or diesters), or hydroxyacids (or hydroxyesters). Preferably, the polyester is an aliphatic or semiaromatic polyester. More preferably the polyester is a semiaromatic polyester. Preferably, the polyester comprises 1,4-butanediol, adipic acid and terephthalic acid in polymerized form.

Suitable polyester are aliphatic polyester. These include homopolymers of aliphatic hydroxycarboxylic acids or lactones, and also copolymers or block copolymers of different hydroxycarboxylic acids or lactones or mixtures of these. These aliphatic polyesters may also contain units of diols and/or of isocyanates. The aliphatic polyesters may also contain units which derive from tri- or polyfunctional compounds, for example from epoxides, from acids or from triols. The aliphatic polyesters may contain the latter units as individual units, or a number of these, possibly together with the diols and/or isocyanates. Processes for preparing aliphatic polyesters are known to the skilled worker. In preparing the aliphatic polyesters it is, of course, also possible to use mixtures made from two or more comonomers and/or from other units, for example from epoxides or from polyfunctional aliphatic or aromatic acids, or from polyfunctional alcohols. The aliphatic polyesters generally have molar asses (number-average) of from 10,000 to 100,000 g/mol.

Examples of aliphatic polyesters are polymeric reaction products of lactic acid, poly-3-hydroxybutanoates, or polyesters built up from aliphatic or cycloaliphatic dicarboxylic acids and from aliphatic or cycloaliphatic diols. The aliphatic polyesters may also be random or block copolyesters which contain other monomers. The proportion of the other monomers is generally up to 10 percent by weight. Preferred comonomers are hydroxycarboxylic acids or lactones or mixtures of these.

Polymeric reaction products of lactic acid are known per se or may be prepared by processes known per se. Besides polylactide, use may also be made of those copolymers or block copolymers based on lactic acid with other monomers. Linear polylactides are mostly used. However, branched lactic acid polymers may also be used. Examples of branching agents are polyfunctional acids or alcohols. Polylactides which may be mentioned as an example are those obtainable essentially from lactic acid or from its C1-C4-alkyl esters or mixtures of these, with at least one aliphatic C4-C10 dicarboxylic acid and with at least one C3-C10 alkanol having from three to five hydroxyl groups.

Poly-3-hydroxybutanoates are homopolymers or copolymers of 3-hydroxybutanoic acid or mixtures thereof with 4-hydroxybutanoic acid and with 3-hydroxyvaleric acid, in particular with a proportion by weight of up to 30 percent, preferably up to 20 percent, of the last-named acid. Suitable polymers of this type also include those with R-stereospecific configuration. Polyhydroxybutanoates or copolymers of these can be prepared microbially. Processes for the preparation from various bacteria and fungi are known as well as a process for preparing stereospecific polymers. It is also possible to use block copolymers of the above-mentioned hydroxycarboxylic acids or lactones, or of their mixtures, oligomers or polymers.

Suitable Polyesters built up from aliphatic or cycloaliphatic dicarboxylic acids and from aliphatic or cycloaliphatic diols are those built up from aliphatic or cycloaliphatic dicarboxylic acids or from mixtures of these, and from aliphatic or cycloaliphatic diols, or from mixtures of these. According to the invention either random or block copolymers may be used. Suitable aliphatic dicarboxylic acids according to the invention generally have from 2 to 10 carbon atoms, preferably from 4 to 6 carbon atoms. They may be either linear or branched. For the purposes of the present invention, cycloaliphatic dicarboxylic acids which may be used are generally those having from 7 to 10 carbon atoms, and in particular those having 8 carbon atoms. However, in principle use may also be made of dicarboxylic acids having a larger number of carbon atoms, for example having up to 30 carbon atoms. Examples which should be mentioned are: malonic acid, succinic acid, glutaric acid, adipic acid, pimelic acid, azelaic acid, sebacic acid, fumaric acid, 2,2-dimethylglutaric acid, suberic acid, 1,3-cyclopentanedicarboxylic acid, 1,4-cyclohexanedicarboxylic acid, 1,3-cyclohexanedicarboxylic acid, diglycolic acid, itaconic acid, maleic acid and 2,5-norbornanedicarboxylic acid, preferably adipic acid. Mention should also be made of ester-forming derivatives of the abovementioned aliphatic or cycloaliphatic dicarboxylic acids, which may likewise be used, in particular the di-C1-C6-alkyl esters, such as dimethyl, diethyl, di-n-propyl, diisopropyl, di-n-butyl, diisobutyl, di-tert-butyl, di-n-pentyl, diisopentyl and di-n-hexyl esters. Anhydrides of the dicarboxylic acids may likewise be used. The dicarboxylic acids or ester-forming derivatives of these may be used individually or as a mixture of two or more of these.

Suitable aliphatic or cycloaliphatic diols generally have from 2 to 10 carbon atoms, preferably from 4 to 6 carbon atoms. They may be either linear or branched. Examples are 1,4-butanediol, ethylene glycol, 1,2- or 1,3-propanediol, 1,6-hexanediol, 1,2- or 1,4-cyclohexanediol or mixtures of these.

Examples of aliphatic polyesters which may be used are aliphatic copolyesters as described in WO 94/14870, in particular aliphatic copolyesters made from succinic acid, from its diesters, or from mixtures with other aliphatic acids or, respectively, diesters, for example glutaric acid and butanediol, or mixtures made from this diol with ethylene glycol, propanediol or hexanediol or mixtures of these. In another embodiment, preferred aliphatic polyesters include polycaprolactone.

According to the invention, the term semiaromatic polyesters refers to polyester, which comprise aliphatic and aromatic monomers in polymerizied form. The term semiaromatic polyesters is also intended to include derivatives of semiaromatic polyesters, such as semiaromatic polyetheresters, semiaromatic polyesteramides, or semiaromatic polyetheresteramides. Among the suitable semiaromatic polyesters are linear non-chain-extended polyesters (WO 92/09654). Preference is given to chain-extended and/or branched semiaromatic polyesters. The latter are disclosed in the specifications mentioned at the outset, WO 96/15173, WO 96/15174, WO 96/15175, WO 96/15176, WO 96/21689, WO 96/21690, WO 96/21691, WO 96/21689, WO 96/25446, WO 96/25448, and WO 98/12242, expressly incorporated herein by way of reference. Mixtures of different semiaromatic polyesters may also be used. In particular, the term semiaromatic polyesters is intended to mean products such as Ecoflex® (BASF SE) and Eastar® Bio and Origo-Bi (Novamont).

Among the particularly preferred semiaromatic polyesters are polyesters which comprise the following significant components
A) an acid component composed of
   a1) from 30 to 99 mol % of at least one aliphatic, or at least one cycloaliphatic, dicarboxylic acid, or its ester-forming derivatives, or a mixture of these
   a2) from 1 to 70 mol % of at least one aromatic dicarboxylic acid, or its ester-forming derivative, or a mixture of these, and
   a3) from 0 to 5 mol % of a compound comprising sulfonate groups,
   and
B) a diol component selected from at least one C₂-C₁₂ alkanediol and at least one C₅-C₁₀ cycloalkanediol, or a mixture of these.

If desired, the semiaromatic polyester may also comprise one or more components selected from C) and D), wherein
C) is a component selected from
   c1) at least one dihydroxy compound comprising ether functions and having the formula I

HO—[(CH₂)ₙ—O]ₘ—H (I)
where n is 2, 3 or 4 and m is a whole number from 2 to 250,
c2) at least one hydroxycarboxylic acid of the formula IIa or IIb

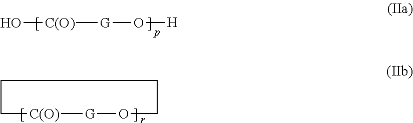

where p is a whole number from 1 to 1500 and r is a whole number from 1 to 4, and G is a radical selected from the group consisting of phenylene, —(CH₂)_{q}—, where q is a whole number from 1 to 5, —C(R)H— and —C(R)HCH₂, where R is methyl or ethyl,
c3) at least one amino-C₂-C₁₂ alkanol, or at least one amino-C₅-C₁₀ cycloalkanol, or a mixture of these,
c4) at least one diamino-C₁-C₈ alkane,
c5) at least one 2,2′-bisoxazoline of the formula III

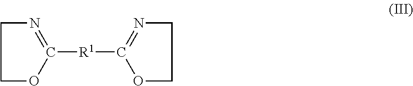

where R¹ is a single bond, a (CH₂)_{z}-alkylene group, where z=2, 3 or 4, or a phenylene group,
c6) at least one aminocarboxylic acid selected from the group consisting of the naturally occurring amino acids, polyamides obtainable by polycondensing a dicarboxylic acid having from 4 to 6 carbon atoms with a diamine having from 4 to 10 carbon atoms, compounds of the formulae IVa and IVb

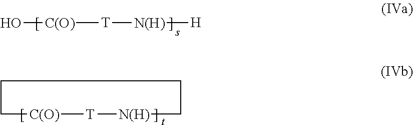

where s is a whole number from 1 to 1500 and t is a whole number from 1 to 4, and T is a radical selected from the group consisting of phenylene, —(CH₂)ᵤ—, where u is a whole number from 1 to 12, —C(R²)H— and —C(R²)HCH₂—, where R² is methyl or ethyl,
and polyoxazolines having the repeat unit V

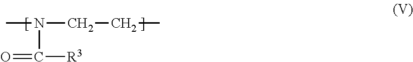

where R³ is hydrogen, C₁-C₆-alkyl, C₅-C₈-cycloalkyl, phenyl, either unsubstituted or with up to three C₁-C₄-alkyl substituents, or tetrahydrofuryl,
or a mixture composed of c1 to c6,
and wherein
D) is a component selected from
   d1) at least one compound having at least three groups capable of ester formation,
   d2) at least one isocyanate,
   d3) at least one divinyl ether,
   or a mixture composed of d1) to d3).

In one preferred embodiment, the acid component A of the semiaromatic polyesters comprises from 30 to 70 mol %, in particular from 40 to 60 mol %, of a1, and from 30 to 70 mol %, in particular from 40 to 60 mol %, of a2.

Aliphatic acids and the corresponding derivatives a1 which may be used are generally those having from 2 to 10 carbon atoms, preferably from 4 to 6 carbon atoms. They may be either linear or branched. The cycloaliphatic dicarboxylic acids which may be used for the purposes of the present invention are generally those having from 7 to 10 carbon atoms and in particular those having 8 carbon atoms. In principle, however, it is also possible to use dicarboxylic acids having a larger number of carbon atoms, for example having up to 30 carbon atoms.

Examples which may be mentioned are: malonic acid, succinic acid, glutaric acid, 2-methylglutaric acid, 3-methylglutaric acid, adipic acid, pimelic acid, azelaic acid, sebacic acid, fumaric acid, 2,2-dimethylglutaric acid, suberic acid, 1,3-cyclopentanedicarboxylic acid, 1,4-cyclohexanedicarboxylic acid, 1,3-cyclohexanedicarboxylic acid, diglycolic acid, itaconic acid, maleic acid, brassylic acid, and 2,5-norbornanedicarboxylic acid.

Ester-forming derivatives of the abovementioned aliphatic or cycloaliphatic dicarboxylic acids which may also be used and which may be mentioned are in particular the di-C₁-C₆-alkyl esters, such as dimethyl, diethyl, di-n-propyl, diisopropyl, di-n-butyl, diisobutyl, di-tert-butyl, di-n-pentyl, diisopentyl or di-n-hexyl esters. It is also possible to use anhydrides of the dicarboxylic acids.

The dicarboxylic acids or their ester-forming derivatives may be used here individually or in the form of a mixture composed of two or more of these.

It is preferable to use succinic acid, adipic acid, azelaic acid, sebacic acid, brassylic acid, or respective ester-forming derivatives thereof, or a mixture of these. It is particularly preferable to use succinic acid, adipic acid, or sebacic acid, or respective ester-forming derivatives thereof, or a mixture of these. It is particularly preferable to use adipic acid or its ester-forming derivatives, for example its alkyl esters, or a mixture thereof. The aliphatic dicarboxylic acid used preferably comprises sebacic acid or a mixture of sebacic acid with adipic acid, if polymer mixtures with “hard” or “brittle” components ii), for example polyhydroxybutyrate or in particular polylactide, are prepared. The aliphatic dicarboxylic acid used preferably comprises succinic acid or a mixture of succinic acid with adipic acid if polymer mixtures with “soft” or “tough” components ii), for example polyhydroxybutyrate-co-valerate, are prepared.

A further advantage of succinic acid, azelaic acid, sebacic acid, and brassylic acid is that they are accessible renewable raw materials.

Aromatic dicarboxylic acids a2 which may be mentioned are generally those having from 8 to 12 carbon atoms and preferably those having 8 carbon atoms. By way of example, mention may be made of terephthalic acid, isophthalic acid, 2,6-naphthoic acid and 1,5-naphthoic acid, and also ester-forming derivatives of these. Particular mention may be made here of the di-C₁-C₆-alkyl esters, e.g. dimethyl, diethyl, di-n-propyl, diisopropyl, di-n-butyl, diisobutyl, di-tert-butyl, di-n-pentyl, diisopentyl, or di-n-hexyl esters. The anhydrides of the dicarboxylic acids a2 are also suitable ester-forming derivatives.

However, in principle it is also possible to use aromatic dicarboxylic acids a2 having a greater number of carbon atoms, for example up to 20 carbon atoms.

The aromatic dicarboxylic acids or ester-forming derivatives of these a2 may be used individually or as a mixture of two or more of these. It is particularly preferable to use terephthalic acid or ester-forming derivatives thereof, such as dimethyl terephthalate.

The compound used comprising sulfonate groups is usually one of the alkali metal or alkaline earth metal salts of a sulfonate-containing dicarboxylic acid or ester-forming derivatives thereof, preferably alkali metal salts of 5-sulfoisophthalic acid or a mixture of these, particularly preferably the sodium salt.

In one of the preferred embodiments, the acid component A comprises from 40 to 60 mol % of a1, from 40 to 60 mol % of a2 and from 0 to 2 mol % of a3. In another preferred embodiment, the acid component A comprises from 40 to 59.9 mol % of a1, from 40 to 59.9 mol % of a2 and from 0.1 to 1 mol % of a3, in particular from 40 to 59.8 mol % of a1, from 40 to 59.8 mol % of a2 and from 0.2 to 0.5 mol % of a3.

The diols B are generally selected from the group consisting of branched or linear alkanediols having from 2 to 12 carbon atoms, preferably from 4 to 6 carbon atoms, or from the group consisting of cycloalkanediols having from 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethyl-1,3-hexanediol, 2,2-dimethyl-1,3-propanediol, 2-ethyl-2-butyl-1,3-propanediol, 2-ethyl-2-isobutyl-1,3-propanediol and 2,2,4-trimethyl-1,6-hexanediol, in particular ethylene glycol, 1,3-propanediol, 1,4-butanediol or 2,2-dimethyl-1,3-propanediol (neopentyl glycol); cyclopentanediol, 1,4-cyclohexanediol, 1,2-cyclohexanedimethanol, 1,3-cyclohexanedimethanol, 1,4-cyclohexanedimethanol or 2,2,4,4-tetramethyl-1,3-cyclobutanediol. Particular preference is given to 1,4-butanediol, in particular in combination with adipic acid as component a1), and 1,3-propanediol, in particular in combination with sebacic acid as component a1). Another advantage of 1,3-propanediol is that it is an available renewable raw material. It is also possible to use mixtures of different alkanediols.

Depending on whether an excess of acid groups or of OH end groups is desired, either component A or component B may be used in excess. In one preferred embodiment, the molar ratio of the components A and B used may be from 0.4:1 to 1.5:1, preferably from 0.6:1 to 1.1:1.

Besides components A and B, the polyesters on which the polyester mixtures of the invention are based may comprise other components.

Dihydroxy compounds c1 which are preferably used are diethylene glycol, triethylene glycol, polyethylene glycol, polypropylene glycol and polytetrahydrofuran (polyTHF), particularly preferably diethylene glycol, triethylene glycol and polyethylene glycol, and mixtures of these may also be used, as may compounds which have different variables n (see formula I), for example polyethylene glycol which comprises propylene units (n=3), obtainable, for example, by using methods of polymerization known per se and polymerizing first with ethylene oxide and then with propylene oxide, and particularly preferably a polymer based on polyethylene glycol with different variables n, where units formed from ethylene oxide predominate. The molar mass (Mₙ) of the polyethylene glycol is generally selected within the range from 250 to 8000 g/mol, preferably from 600 to 3000 g/mol.

In one of the preferred embodiments for preparing the semiaromatic polyesters use may be made, for example, of from 15 to 98 mol %, preferably from 60 to 99.5 mol %, of the diols B and from 0.2 to 85 mol %, preferably from 0.5 to 30 mol %, of the dihydroxy compounds c1, based on the molar amount of B and c1.

In one preferred embodiment, the hydroxycarboxylic acid c2) used is: glycolic acid, D-, L- or D,L-lactic acid, 6-hydroxyhexanoic acid, cyclic derivatives of these, such as glycolide (1,4-dioxane-2,5-dione), D- or L-dilactide (3,6-dimethyl-1,4-dioxane-2,5-dione), p-hydroxybenzoic acid, or else their oligomers and polymers, such as 3-polyhydroxybutyric acid, polyhydroxyvaleric acid, polylactide (obtainable, for example, as NatureWorks® 4042D (NatureWorks) or else a mixture of 3-polyhydroxybutyric acid and polyhydroxyvaleric acid (obtainable from PHB Industrial, Tianan, or Metabolix) and, for preparing semiaromatic polyesters, particularly preferably the low-molecular-weight and cyclic derivatives thereof.

Examples of amounts which may be used of the hydroxycarboxylic acids are from 0.01 to 50% by weight, preferably from 0.1 to 40% by weight, based on the amount of A and B.

The amino-C₂-C₁₂ alkanol or amino-C₆-C₁₀ cycloalkanol used (component c3) which for the purposes of the present invention also include 4-aminomethylcyclohexanemethanol, are preferably amino-C₂-C₆ alkanols, such as 2-aminoethanol, 3-aminopropanol, 4-aminobutanol, 5-aminopentanol or 6-aminohexanol, or else amino-C₅-C₆ cycloalkanols, such as aminocyclopentanol and aminocyclohexanol, or mixtures of these.

The diamino-C₁-C₈ alkanes (component c4) used are preferably diamino-C₄-C₆ alkanes, such as 1,4-diaminobutane, 1,5-diaminopentane or 1,6-diaminohexane (hexamethylenediamine, “HMD”).

In one preferred embodiment for preparing the semiaromatic polyesters, use may be made of from 0.5 to 99.5 mol %, preferably from 0.5 to 50 mol %, of c3, based on the molar amount of B, and of from 0 to 50 mol %, preferably from 0 to 35 mol %, of c4, based on the molar amount of B.

The 2,2′-bisoxazolines c5 of the formula III are generally obtainable via the process of Angew. Chem. Int. Edit., Vol. 11 (1972), pp. 287-288. Particularly preferred bisoxazolines are those where R¹ is a single bond, (CH₂)_{z}-alkylene, where z=2, 3 or 4, for example methylene, ethane-1,2-diyl, propane-1,3-diyl or propane-1,2-diyl, or a phenylene group. Particularly preferred bisoxazolines which may be mentioned are 2,2′-bis(2-oxazoline), bis(2-oxazolinyl)methane, 1,2-bis(2-oxazolinyl)ethane, 1,3-bis(2-oxazolinyl)propane and 1,4-bis(2-oxazolinyl)butane, in particular 1,4-bis(2-oxazolinyl)benzene, 1,2-bis(2-oxazolinyl)benzene or 1,3-bis(2-oxazolinyl)benzene.

In preparing the semiaromatic polyesters use may, for example, be made of from 70 to 98 mol % of B, up to 30 mol % of c3 and from 0.5 to 30 mol % of c4 and from 0.5 to 30 mol % of c5, based in each case on the total of the molar amounts of components B, c3, c4 and c5. In another preferred embodiment, use may be made of from 0.1 to 5% by weight, preferably from 0.2 to 4% by weight, of c5, based on the total weight of A and B.

The component c6 used may be naturally occurring aminocarboxylic acids. These include valine, leucine, isoleucine, threonine, methionine, phenylalanine, tryptophan, lysine, alanine, arginine, aspartamic acid, cysteine, glutamic acid, glycine, histidine, proline, serine, tyrosine, asparagine and glutamine.

Preferred aminocarboxylic acids of the formulae IVa and IVb are those where s is a whole number from 1 to 1000 and t is a whole number from 1 to 4, preferably 1 or 2, and t has been selected from the group consisting of phenylene and —(CH₂)ᵤ—, where u is 1, 5, or 12.

c6 may also be a polyoxazoline of the formula V. However, c6 may also be a mixture of different aminocarboxylic acids and/or polyoxazolines.

In one preferred embodiment, the amount of c6 used may be from 0.01 to 50% by weight, preferably from 0.1 to 40% by weight, based on the total amount of components A and B.

Among other components which may be used, if desired, for preparing the semiaromatic polyesters are compounds d1 which comprise at least three groups capable of ester formation.

The compounds d1 preferably comprise from three to ten functional groups which are capable of developing ester bonds. Particularly preferred compounds d1 have from three to six functional groups of this type in the molecule, in particular from three to six hydroxy groups and/or carboxy groups. Examples which should be mentioned are: tartaric acid, citric acid, maleic acid; trimethylolpropane, trimethylolethane; pentaerythritol; polyethertriols; glycerol; trimesic acid; trimellitic acid, trimellitic anhydride; pyromellitic acid, pyromellitic dianhydride, and hydroxyisophthalic acid.

The amounts generally used of the compounds d1 are from 0.01 to 15 mol %, preferably from 0.05 to 10 mol %, particularly preferably from 0.1 to 4 mol %, based on component A.

Components d2 used are an isocyanate or a mixture of different isocyanates. Aromatic or aliphatic diisocyanates may be used. However, higher-functionality isocyanates may also be used. For the purposes of the present invention, aromatic diisocyanate d2 is especially tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate or xylylene diisocyanate. By way of example, it is possible to use the isocyanates obtainable as Basonat® from BASF Aktiengesellschaft.

Among these, particular preference is given to diphenylmethane 2,2′-, 2,4′- and 4,4′-diisocyanate as component d2. The latter diisocyanates are generally used as a mixture.

A three-ring isocyanate d2 which may also be used is tri(4-isocyanophenyl)methane. Multi-ringed aromatic diisocyanates arise during the preparation of single- or two-ring diisocyanates, for example.

Component d2 may also comprise subordinate amounts, e.g. up to 5% by weight, based on the total weight of component d2, of uretdione groups, for example for capping the isocyanate groups.

For the purposes of the present invention, an aliphatic diisocyanate d2 is primarily a linear or branched alkylene diisocyanate or cycloalkylene diisocyanate having from 2 to 20 carbon atoms, preferably from 3 to 12 carbon atoms, e.g. hexamethylene 1,6-diisocyanate, isophorone diisocyanate, or methylenebis(4-isocyanatocyclohexane). Hexamethylene 1,6-diisocyanate and isophorone diisocyanate are particularly preferred aliphatic diisocyanates d2.

Among the preferred isocyanurates are the aliphatic isocyanurates which derive from C₂-C₂₀, preferably C₃-C₁₂, cycloalkylene diisocyanates or alkylene diisocyanates, e.g. isophorone diisocyanate or methylenebis(4-isocyanatocyclohexane). The alkylene diisocyanates here may be either linear or branched. Particular preference is given to isocyanurates based on n-hexamethylene diisocyanate, for example cyclic trimers, pentamers, or higher oligomers of n-hexamethylene diisocyanate.

The amounts generally used of component d2 are from 0.01 to 5 mol %, preferably from 0.05 to 4 mol %, particularly preferably from 0.1 to 4 mol %, based on the total of the molar amounts of A and B.

Divinyl ethers d3 which may be used are generally any of the customary and commercially available divinyl ethers. Preference is given to the use of 1,4-butanediol divinyl ethers, 1,6-hexanediol divinyl ethers or 1,4-cyclohexanedimethanol divinyl ethers or a mixture of these.

The amounts of the divinyl ethers preferably used are from 0.01 to 5% by weight, especially from 0.2 to 4% by weight, based on the total weight of A and B.

Examples of preferred semiaromatic polyesters are based on the following components: A, B, d1; A, B, d2; A, B, d1, d2; A, B, d3; A, B, c1; A, B, c1, d3; A, B, c3, c4; A, B, c3, c4, c5; A, B, d1, c3, c5; A, B, c3, d3; A, B, c3, d1; A, B, c1, c3, d3; or A, B, c2. Among these, particular preference is given to semiaromatic polyesters based on A, B and d1, or A, B and d2, or on A, B, d1 and d2. In another preferred embodiment, the semiaromatic polyesters are based on A, B, c3, c4 and c5 or A, B, d1, c3 and c5.

The starch comprises preferably one or more of corn, potato, wheat, rice, sago, tapioca, waxy maize, sorghum, and cassava starch. More preferably, the starch is a thermoplastic starch, which may be obtained from native starch in the presence of a plasticizer when heated and sheared. Suitable plasticizers include polyhydric alcohols, for example glycerol, sorbitol, ethylene glycol, and mixtures thereof. Glycerol is a most suitable plasticizer.

In another preferred embodiment, the foil is free of plasticizers, such as glycerol. Such foils are also commerically available, e.g. from the company Biotec® the products of the Bioplast® WRAP series, which are based on potato starch.

In a preferred embodiment, the polyester and the starch form a heterophase polymeric composition. Such compositions are known from WO 98/20073. Preferably, the polymeric composition comprises the polyester, the starch and the plasticizer. Typically, the composition comprises 20-95 wt % starch, more preferably 30-75 wt %. Typically, the composition comprises 5-80 wt % of polyester. Typically, the composition comprises 10-30 wt % plasticizer relative to the amount of starch. The composition is obtainable by extrusion, e.g. at 100 to 220° C. and shearing forces. The starch may be treated to render it thermoplastic before being mixed with the other components of the composition or during the mixing of the components. Preferably, the polymeric composition is composed and obtainable as described in WO 98/20073, page 21 second paragraph to page 25, 6th paragraph as well as in Example 1B and 2B (both citations are included by reference herewith).

In a preferred embodiment, the polyester and the starch form a starch-polyester graft copolymer. The graft copolymer usually comprises (a) a thermoplastic starch, which comprises a high-amylose starch and a plasticizer, and (b) segments of a biodegradable polyester grafted onto the thermoplastic starch. The thermoplastic starch comprises preferably a modified thermoplastic starch, which preferably comprises a reactively blended mixture of the starch, the plasticizer, a chemical modifier comprising one or more dibasic acids, cyclic anhydrides thereof, or combinations thereof, and an optional free radical initiator. The chemical modifier comprises usually one or more of maleic acid, succinic acid, itaconic acid, phthalic acid, and anhydrides thereof (wherein maleic acid anhydride is preferred). The biodegradable polyester usually comprises one or more aliphatic polyesters, semiaromatic polyesters, and poly(beta-hydroxyalkanoates) (wherein semiaromatic polyesters as described above are preferred). The high-amylose starch comprises preferably one or more of corn, potato, wheat, rice, sago, tapioca, waxy maize, sorghum, and cassava starch. Typically, the high-amylose starch has an amylose content of at least about 40 weight percent. Suitable plasticizers include polyhydric alcohols, for example glycerol, sorbitol, ethylene glycol, and mixtures thereof. Glycerol is a most suitable plasticizer. Such starch polyester graft copolymers are known from for example from Raquez et al, Polymer Eng. Sci. 2008, 1747-1754, WO 2009/073197, WO 2006/055505, and are commercially available as Ecobras® from BASF S.A. Especially preferred starch-polyester graft copolymers are those of described in WO 98/20073, paragraph [27] to [38] and Example 1, to both is reference made herewith.

Preferably, the foil forms a bag. Such bags may have any shape (e.g. rectangular) and may be open on part of it allowing to introduce the bait inside the bag. Preferably, the bag has a length of 5 to 100 cm, more preferably from 15 to 60 cm, and especially from 20 to 40 cm. Preferably, the bag has a width of 3 to 80 cm, more preferably from 8 to 50 cm, and especially from 12 to 30 cm. Typically, one side of the rectangular bag is open. The bag may be closed by knoting the open side of the bag (e.g. as shown in FIG. 1). Typically, it is not necessary to remove the air from the inside of the bag after the rodent bait was placed inside the bag. There may be a volume of air inside the bag, for example the a volume corresponding to a range from 1% to 5000% of the volume of the rodent bait, preferably in the range from 50% to 500%.

Rodent pests to be controlled with the bait system according to the invention are preferably rodents from the order Rodentia, preferably from the family Musidae, in particular Murinae. Particular attention is to be given to the genera Rattus and Mus, Microtus, furthermore also, inter alia, Apodemus, Microtus, Arvicola and Clethrionomys, in particular the species Rattus norvegicus, Rattus rattus, Rattus argentiventer, Rattus exulans, Mus sp. Arvicola terrestris, Microtus arvalis, Microtus pennsylvanicus, Tatera indica, Peromyscus leucopus, Peromyscus maniculatus, Mastomys natalensis, Sigmodon hispidus, Arvicanthis niloticus, Bandicota bengalensis, Bandicota indica, Nesokia indica, Meriones hurrinanae and Millardia meltada. Very especially attention is to be given to the representatives of the genera Rattus and Mus, for example R. rattus, R. norvegicus, M. musculus, preferably.

In addition, the bait system according to the invention are also suitable for controlling other harmful vertebrates, for example opossums (vulpes vulpes), and American opossums (Didelphidae), brushtail possums (Trichosurus, in particular the common brushtail possum (Trichosurus vulpecula), nutria (Myocastor coypus), rabbit (i.e. suitable genera from the subfamily Leporinae and raccoons, in particular Procyon Cofor.

The present invention also relates to a method for controlling rodents, comprising the steps of
a) packing the rodent bait (as described above) in the biodegradable foil (as described above), and
b) offering the packed bait to rodents.

Preferably, in step a) the rodent bait is packed in a biodegradable foil in the form of a bag, and the bag is closed (e.g. by knotting it).

Typically, for offering the packed baits in step b) the packed baits are placed in the habitat of the rodents to be controlled. The distance between two baits is usually in the range between 1 to 30 m, preferably 5 to 10 m. Professional pesticide controllers are well aware of suitable ways for offering the packed baits to rodents. After the bait system was offered to the rodents, it is usually take away by them within one or two weeks. The rodents often take the bait system into their caves and eat it. Usually, the whole bait system including the biodegradable foil is eaten.

Preferably, the end user carries out steps a) and b). For example, he may buy a procuct which contains the rodent baits and the biodegradable foil (e.g. in the form of a bag) separately. Then he may pack himself the rodent bait inside the biodegradable foil and place the packed bait in the habitat of the rodents.

The present invention further relates to a bait system comprising, as separate components,
a) the rodent bait (as described above), and
b) the biodegradable foil (as described above),
   for combined use in controlling rodents. Such a bait system would allow the end user to pack the rodent bait in the biodegradable foil, and offer the packed bait to rodents.

Thus, commercially available biodegradable foil could easily be used. This would result in a cheap bait system, which is easy to handle for the end user.

There are several advantages of the present invention: The bait system results in no waste after it is taken away by rodents. Thus, this system allows the protection of the environment. Further on said system is based on industrially available materials, it works with commercial bait formulations, it is storage stable, it is to rodents, and it is easy and safe to handle for the pest control operators. There is also no rejection of the biodegradable foil by the rodents. The starch, which is comprised in the biodegradable foil, is attractive to rodents. Non-target animals are kept away from the bait due to the packing of the bait. The rodent bait is protected from humidity and rain, and thus maintains it palatable. When the foil forms a bag it can easily be knotted, which results in a bag with a tail. Such a tail can help in the monitoring of the bait system because it is easily visible. Such a tail also allows to launch the bait system manually in order to reach high bait places, and it allows to carry a lot of bags in one hand, even without special protection gloves. After concluding the program, the packed rodent bait, which was not consumed, may be collected and reused again.

Another advantage is that the baits system is taken by the rodents into their nests, which is a safe and quiet place for the colony and where the bait can be eaten by all members of the colony. This is the typical habit of rodents when they can carry away a bait. Once the bait system is in the underground nest it remains under the ground far away from non target animals or human being. Thus, this is a very safe method of application. In addition, the rodents generaly die under the soil and this reduces the contamination on the ground (e.g. strong smell, spread of parasits, flies of putrefaction and diseases like salmonella). Further on, a high mortality (i.e. high effectiveness) with few amount of bait system is achieved. Finally, all residues of the bait system, including the biodegradable foil, will remain under the ground and the decomposition will be carry out by the bacteria and fungi, which transform the biodegradable film into organic material.

### EXAMPLES

Ecobras® foil is an extrusion blend of Ecoflex® and of 50 wt % modified corn starch. It is commercially available from BASF S.A., Brazil and has a foil thickness of 20 μm. The density was 1.32 g/cm³ (ISO 1183), melting point was 116-122° C. (DSC), modulus of elasticity was 300 Mpas (ASTM D638), VICAT VST A/50 softening temperatur was 66° C. (ISO 306).
Ecoflex® is an aliphatic aromatic copolyester, commercially available form BASF SE. Ecoflex® is a polycondensate of 1,4-butanediol, adipic acid and terephthalic acid (melting point 110-120° C. as determined by DSC; tensile strength 34 N/mm² as determined by ISO 527; ultimate elongation (MD) 560% as determined by ISO 527; water permeation rate 140 g/(m²*d) as deteremind by DIN 53122). Storm® block baits (each 3.5+/−0.4 g) were commercially available from BASF SE and contained 0.005 wt % flocoumafen. These blue coloured, prolate spheroid shaped (see FIG. 1) blocks (approximate dimensions: length 3 cm, width 2 cm, height 1 cm) contained 25 wt % wax (melting point 65° C.), 37 wt % flour, 37 wt % cut wheat.
Testing area: Six different closed properties and houses in Buenos Aires, Argentina, including rural-urban areas as well as production facilities and private homes. All testing area had severe problems with rats.

Three Storm® block baits were packed in a bag (20 cm width, 31 cm length) made of Ecobras® foil and knotted. FIG. 1 shows an example of the knotted bag (in this case with four blocks packed inside). The bags were placed out in cave mouths and specific places according to the pattern of rodents in the testing areas. In general, the distance between the bags was 5 to 10 m. After seven days, all bags were taken away by the rodents. Dead rodents were observed inside their caves. The rodent population was clearly reduced.

For comparison, Storm® block baits were packed in bags made of polyethylene (PE) foil. Both Ecobras® and PE bait bags (same number) were placed in the testing area at the same time. All bags were removed after seven days. The reduction of the rodent population was comparable when the same number of Storm® block in polyethylene foil or in EcoBras® foil were placed in the testing areas. Thus, there was no rejection of the EcoBras® bag whatsoever found. When grain bait or pellet baits were used in bags, they were partly spread in the testing area.

1-14. (canceled)

15. A bait system comprising a rodent block bait packed in a biodegradable foil containing polyester and starch, wherein at least two dimensions of the rodent block bait have a size of at least 1.0 cm.

16. The bait system of claim 15, wherein the rodent block bait has a weight in the range of 1 to 30 g.

17. The bait system of claim 15, wherein the foil has a thickness in the range of 1 to 50 μm.

18. The bait system of claim 15, wherein the foil forms a bag.

19. The bait system of claim 18, wherein a volume of air is inside the bag.

20. The bait system of claim 18, wherein the bag has a width in the range of 3 to 80 cm and a length in the range of 5 to 100 cm.

21. The bait system of claim 15, wherein the foil contains at least 20 wt % starch.

22. The bait system of claim 15, wherein the polyester is a semiaromatic copolyester.

23. The bait system of claim 15, wherein the polyester comprises 1,4-butanediol, adipic acid and terephthalic acid in polymerized form.

24. The bait system of claim 15, wherein the polyester and the starch form a starch-polyester graft copolymer.

25. The bait system of claim 15, wherein the rodent block bait has a length in the range of 2.0 cm to 7.0 cm, a width in the range of 1.3 to 6.0 cm and a height in the range of 0.7 to 4.0 cm.

26. The bait system of claim 15, wherein the rodent block bait is substantially spherical.

27. A method for controlling rodents, comprising
a) packing a rodent block bait in a biodegradable foil containing a polyester and a starch, wherein at least two dimensions of the rodent block bait have a size of at least 1.0 cm, and
b) offering the packed bait to rodents.

28. The method according to claim 27, wherein steps a) and b) are carried out by the end user.

30. The method of claim 27, wherein the rodent block bait has a weight in the range of 1 to 30 g.

31. The method of claim 27, wherein the foil contains at least 20 wt % starch.

32. A bait system comprising, as separate components,
a) a rodent block bait having at least two dimensions having a size of at least 1.0 cm., and
b) a biodegradable foil containing a polyester and a starch, for combined use in controlling rodents.

33. The bait system of claim 32, wherein the rodent block bait has a weight in the range of 1 to 30 g.

34. The bait system of claim 32, wherein the foil contains at least 20 wt % starch.
